(19) United States
(12) Patent Application Publication
(10) Pub. No.: US 2025/0332803 A1
(43) Pub. Date: Oct. 30, 2025

(54) DOUBLE-LAYERED FOAMED PAPER CONTAINER AND MANUFACTURING METHOD THEREOF

(71) Applicant: Ching-Wen CHANG, Miaoli County (TW)

(72) Inventor: Ching-Wen CHANG, Miaoli County (TW)

(21) Appl. No.: 18/867,112

(22) PCT Filed: Jun. 13, 2022
(86) PCT No.: PCT/CN2022/098371

§ 371 Date: Nov. 19, 2024

(51) Int. Cl. B31B 50/74; B31B 50/26; B31B 110/20; B31B 120/00; B31B 120/50; B32B 5/20; B32B 5/32; B32B 7/02; B32B 29/00; B65D 81/38

(52) U.S. Cl. CPC B31B 50/745; B31B 50/26; B31B 50/741; B32B 5/20; B32B 5/32; B32B 7/02; B32B 29/007; B65D 81/3874; B31B 2110/20; B31B 2120/002; B31B 2120/50; B32B 2250/03; B32B 2250/44; B32B 2307/4023; B32B 2307/75; B32B 2439/02

(57) ABSTRACT

The present invention provides a double-layered foamed paper container and a manufacturing method thereof. The manufacturing method of the double-layered foamed paper container includes following steps: applying first foaming material, primary drying, applying second foaming material, secondary drying and heating and foaming. The double-layered foamed paper container includes: a paper container body, having a circumferential wall and defining a receiving space, a first foam layer disposed on at least a portion of a side of the circumferential wall opposite to the receiving space.

### BACKGROUND OF THE INVENTION

### Field of the Invention

The present invention relates to a double-layered foamed paper container and a manufacturing method thereof.

### Description of the Prior Art

A conventional paper container for hot drinks is usually provided with a foam layer or corrugated paper sleeve on its outer surface to achieve thermal insulation effect so that a user can hold the paper container via the foam layer or corrugated paper sleeve. Specifically, the foam layer affects the thermal insulation effect of the paper container. For example, a fluffy and thick foam layer provides good thermal insulation effect, but has poor printing effect due to its large holes. The printing process may damage a structure of the foam layer and reduce the thermal insulation effect of the paper container and production yield.

On the other hand, during processing, a foaming material is coated to the outer surface of the paper container to form the foam layer, and a coating thickness of the foaming material should be thick enough to achieve thermal insulation effect. However, drying the foaming material is time-consuming, and if the foaming material is not dried completely, said paper containers may stick with one another when stacked. A drying temperature of the foaming material may be increased for fast drying; however, high temperature may cause the paper container to deform.

In addition, a paper cup without the foam layer is usually used to hold cold drinks, which has poor thermal insulation effect and is inconvenient to be held by hands, and the cold drinks thaw fast and drops of water appear on an outer surface of the paper cup, causing the paper container to soften and damage.

The present invention is, therefore, arisen to obviate or at least mitigate the above-mentioned disadvantages.

### SUMMARY OF THE INVENTION

The main object of the present invention is to provide a double-layered foamed paper container and a manufacturing method thereof, which is easy to be processed and printed, provides thermal insulation, heat retention and waterproof effects, and is suitable for holding hot and cold drinks.

To achieve the above and other objects, the present invention provides a manufacturing method of a double-layered foamed paper container, including following steps: applying first foaming material: applying a first foaming material to at least a portion of a paper container body; primary drying: drying the first foaming material at a temperature lower than a foaming temperature of the first foaming material; applying second foaming material: applying a second foaming material to at least a portion of a side of the first foaming material opposite to the paper container body; secondary drying: drying the second foaming material at a temperature lower than a foaming temperature of the second foaming material; and heating and foaming: heating the first foaming material and the second foaming material to foam into a first foam layer and a second foam layer respectively.

Specifically, the manufacturing method of the double-layered foamed paper container further includes a step of connection: bending and connecting the paper container body to form a receiving space before the step of heating and foaming.

Specifically, in the step of applying second foaming material, a coating thickness of the second foaming material is different from a coating thickness of the first foaming material.

Specifically, in the step of applying second foaming material, the coating thickness of the second foaming material is larger than the coating thickness of the first foaming material.

Specifically, in the step of applying second foaming material, the coating thickness of the second foaming material is smaller than the coating thickness of the first foaming material.

Specifically, the first foaming material and the second foaming material are the same.

To achieve the above and other objects, the present invention provides a double-layered foamed paper container, manufactured by the manufacturing method of the double-layered foamed paper container as described above, including: the paper container body, having a circumferential wall and defining a receiving space, the first foam layer disposed on at least a portion of a side of the circumferential wall opposite to the receiving space.

Specifically, the first foam layer has a first thickness, the second foam layer has a second thickness, and the first thickness is larger than the second thickness.

Specifically, the first foam layer has a first thickness, the second foam layer has a second thickness, and the first thickness is smaller than the second thickness.

Specifically, a side of the second foam layer opposite to the first foam layer has a printed layer.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a cross-sectional view of a preferable embodiment of the present invention before foaming;

FIG. 3 is a cross-sectional view of a preferable embodiment of the present invention;

FIG. 4 is a schematic diagram of a preferable embodiment of the present invention;

FIG. 5 is a cross-sectional view of another preferable embodiment of the present invention; and

FIG. 6 is a flow chart of a preferable embodiment of the present invention.

### DETAILED DESCRIPTION OF THE PREFERRED EMBODIMENTS

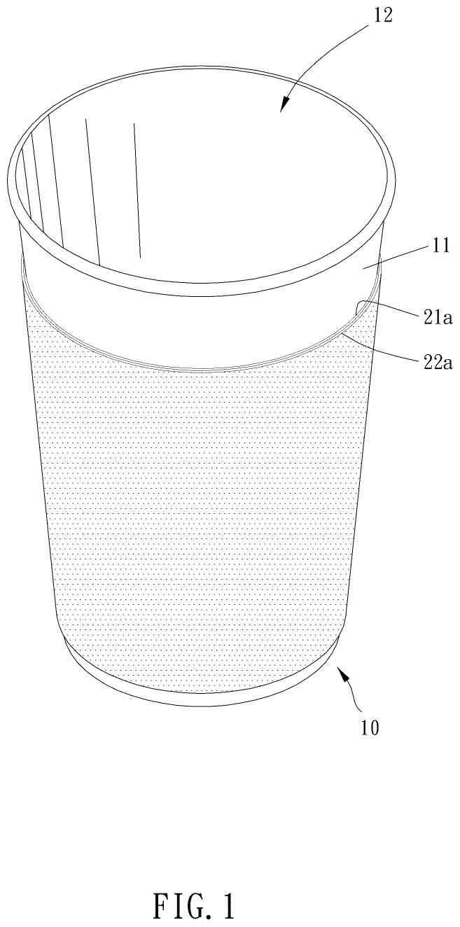

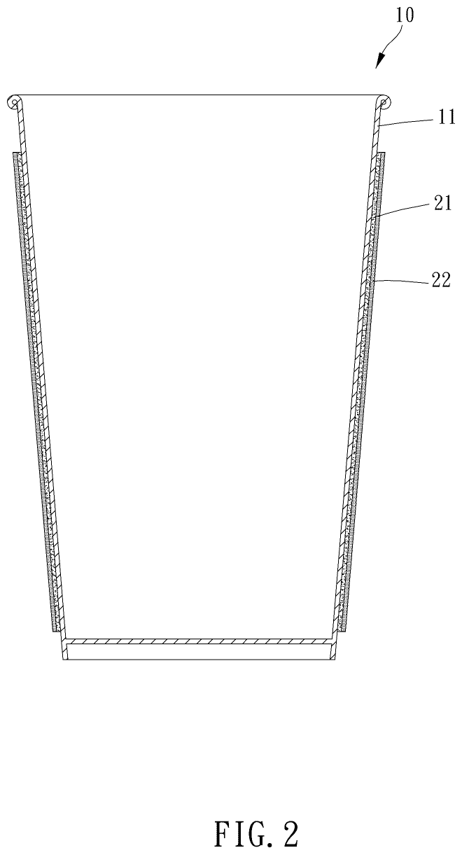

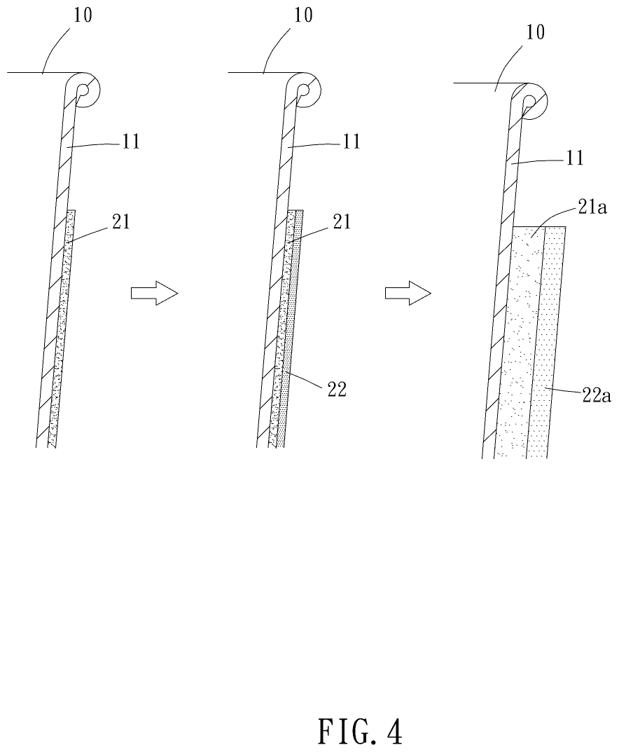

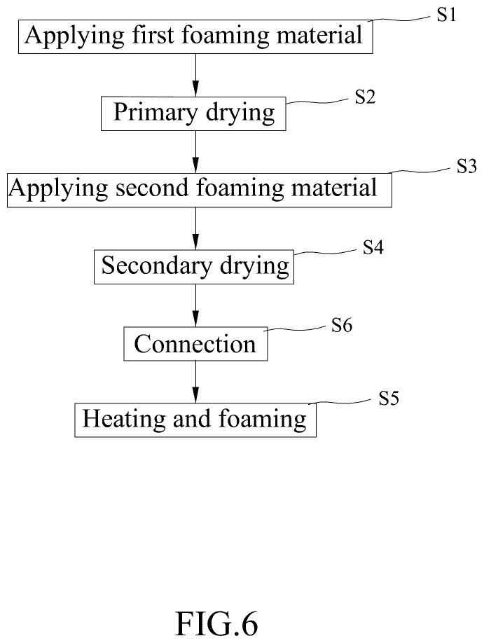

Please refer to FIGS. 1 to 4 and FIG. 6 for a preferable embodiment of the present invention. A double-layered foamed paper container of the present invention includes a paper container body 10, a first foam layer 21a and a second foam layer 22a.

The paper container body 10 has a circumferential wall 11 and defines a receiving space 12. The first foam layer 21a is disposed on at least a portion of a side of the circumferential wall 11 opposite to the receiving space 12 and has a first thickness. The second foam layer 22a is disposed on at least a portion of a side of the first foam layer 21a opposite to the paper container body 10 and has a second thickness, and the first thickness is different from the second thickness. The first thickness and the second thickness is designable to meet different use requirements so that the double-layered foamed paper container is suitable to hold hot drinks or cold drinks and provides thermal insulation, heat retention and waterproof effects.

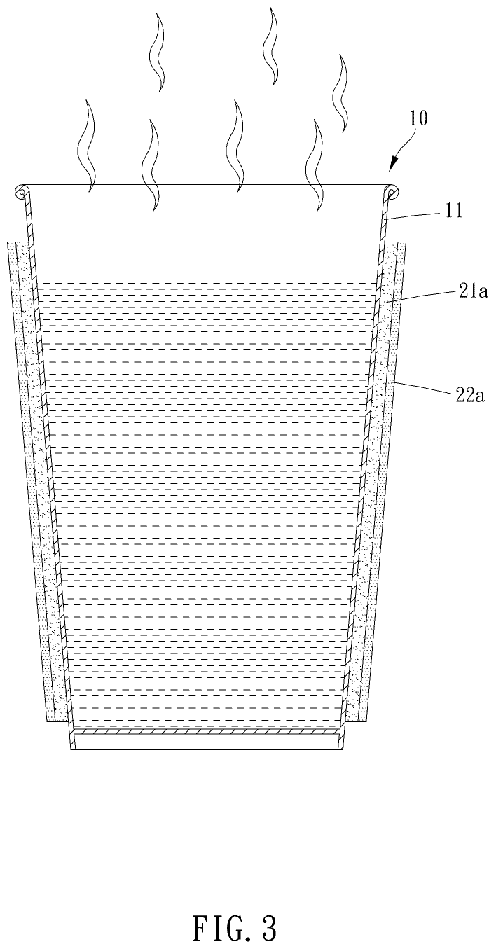

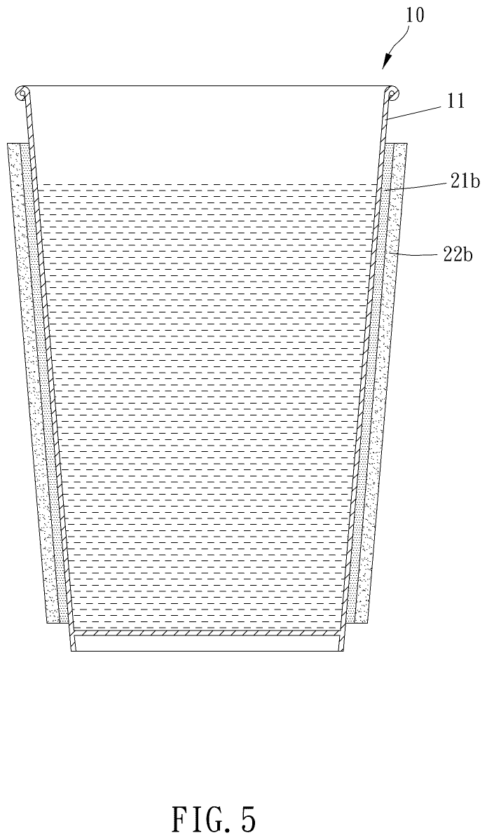

Please refer to FIG. 3, in this embodiment, the first thickness is larger than the second thickness. Therefore, the first foam layer 21a provides thermal insulation and heat retention effects to protect a user's hands and keep the temperature of the hot drink held in the paper container body 10, and the second foam layer 22a provides a compact and smooth surface, which allows a printed layer to be disposed thereon and provides good printing effect. In other embodiments, the first thickness may be smaller than the second thickness, as shown in FIG. 5. Therefore, the first foam layer 21b is stably attached to the circumferential wall 11 to increase a structural strength, and the second foam layer 22b effectively insulates heat transfer between an external environment and the receiving space 12 of the paper container body 10.

The present invention further provides a manufacturing method of the double-layered foamed paper container as described above, including following steps.

Applying first foaming material S1: apply a first foaming material 21 to at least a portion of a circumferential wall 11 of a paper container body 10.

Primary drying S2: dry the first foaming material 21 at a temperature lower than a foaming temperature of the first foaming material 21.

Applying second foaming material S3: apply a second foaming material 22 to at least a portion of a side of the first foaming material 21 opposite to the paper container body 10. Specifically, a coating thickness of the second foaming material 22 is different from a coating thickness of the first foaming material 21. Specifically, the coating thickness of the first foaming material 21 refers to an average coating thickness that the first foaming material 21 applied to the circumferential wall 11, and the coating thickness of the second foaming material 22 refers to an average coating thickness that the second foaming material 22 applied to the first foaming material 21. The coating thickness of the second foaming material 22 may be larger than or smaller than the coating thickness of the first foaming material 21 to meet different requirements so as to manufacture said double-layered foamed paper containers with different functions. Said coating thicknesses of the first foaming material 21 and the second foaming material 22 may be adjusted by changing a mesh size of a coating equipment.

Secondary drying S4: dry the second foaming material 22 at a temperature lower than a foaming temperature of the second foaming material 22. Preferably, the foaming temperature of the second foaming material 22 is also lower than the foaming temperature of the first foaming material 21. With the steps of primary drying S2 and secondary drying S4, the first foaming material 21 and the second foaming material 22 are dry and non-sticky, which is convenient to be process. The first foaming material 21 and the second foaming material 22 are dried separately so as to be easy to dry without requiring a high drying temperature, which is time-saving and increases production speed.

Heating and foaming S5: heat the first foaming material 21 and the second foaming material 22 to foam into a first foam layer 21a and a second foam layer 22a respectively. The first foaming material 21 and the second foaming material 22 are preferably the same so as to have the same foaming temperature and be easy to control foaming degrees of the first foam layer 21a and the second foam layer 22a. Thicknesses of the first foam layer 21a and the second foam layer 22a are adjustable by changing said coating thicknesses of first foaming material 21 and the second foaming material 22, which is easy to be processed. However, the first foaming material and the second foaming material may be different from each other so as to foam at different temperatures and provides foam layers with different densities or thicknesses.

Preferably, before the step of heating and foaming S5, the manufacturing method further includes a step of connection S6: bending and connecting the paper container body 10 to form the receiving space 12. As such, the paper container body 10 is small and easy to be processed, and connecting the paper container body 10 before foaming also avoids poor connection and inconvenient processing due to said foam layers. After the step of heating and foaming S5, the manufacturing method further includes a step of printing: printing a printed layer on a side of the second foam layer 22a opposite to the first foam layer 21a. The printed layer is formed after the step of heating and foaming S5, which prevents colorants of the printed layer from being dispersed due to expansion of the second foaming material 22 and has good printing effect.

Although particular embodiments of the invention have been described in detail for purposes of illustration, various modifications and enhancements may be made without departing from the spirit and scope of the invention. Accordingly, the invention is not to be limited except as by the appended claims.

1. A manufacturing method of a double-layered foamed paper container, including following steps:
applying first foaming material: applying a first foaming material to at least a portion of a paper container body;
primary drying: drying the first foaming material at a temperature lower than a foaming temperature of the first foaming material;
applying second foaming material: applying a second foaming material to at least a portion of a side of the first foaming material opposite to the paper container body;
secondary drying: drying the second foaming material at a temperature lower than a foaming temperature of the second foaming material; and
heating and foaming: heating the first foaming material and the second foaming material to foam into a first foam layer and a second foam layer respectively.

2. The manufacturing method of the double-layered foamed paper container of claim 1, further including a step of connection: bending and connecting the paper container body to form a receiving space before the step of heating and foaming.

3. The manufacturing method of the double-layered foamed paper container of claim 1, wherein in the step of applying second foaming material, a coating thickness of the second foaming material is different from a coating thickness of the first foaming material.

4. The manufacturing method of the double-layered foamed paper container of claim 3, wherein in the step of applying second foaming material, the coating thickness of the second foaming material is larger than the coating thickness of the first foaming material.

5. The manufacturing method of the double-layered foamed paper container of claim 3, wherein in the step of applying second foaming material, the coating thickness of the second foaming material is smaller than the coating thickness of the first foaming material.

6. The manufacturing method of the double-layered foamed paper container of claim 1, wherein the first foaming material and the second foaming material are the same.

7. A double-layered foamed paper container, manufactured by the manufacturing method of the double-layered foamed paper container any of claim 1, including:
the paper container body, having a circumferential wall and defining a receiving space, the first foam layer disposed on at least a portion of a side of the circumferential wall opposite to the receiving space.

8. The double-layered foamed paper container of claim 7, wherein the first foam layer has a first thickness, the second foam layer has a second thickness, and the first thickness is larger than the second thickness.

9. The double-layered foamed paper container of claim 7, wherein the first foam layer has a first thickness, the second foam layer has a second thickness, and the first thickness is smaller than the second thickness.

10. The double-layered foamed paper container of claim 7, wherein a side of the second foam layer opposite to the first foam layer has a printed layer disposed thereon.
